(19) United States
(12) Patent Application Publication
(10) Pub. No.: US 2021/0155469 A1
(43) Pub. Date: May 27, 2021

(54) APPARATUS DISTINGUISHING BETWEEN GASOLINE AND DIESEL OIL IN FUEL-OIL DISPENSERS

(71) Applicant: DEMIRÖREN AGIR METAL SANAYI ANONIM SIRKETI, Izmir (TR)

(72) Inventors: Hüseyin GÖKÇE, Izmir (TR); Mustafa HACIOGLU, Izmir (TR); Zari CANDAL, Izmir (TR)

(21) Appl. No.: 17/045,515

(22) PCT Filed: Nov. 29, 2018
(86) PCT No.: PCT/TR2018/050744

§ 371 Date: Oct. 6, 2020

(30) Foreign Application Priority Data
Sep. 26, 2018 (TR) 2018/14011

(51) Int. Cl. B67D 7/52

(52) U.S. Cl. CPC B67D 7/52

(57) ABSTRACT

A filling apparatus for filling gasoline and diesel vehicles at fuel oil stations and installed onto a fuel oil dispenser having a cap located on dispenser pipe entering into the vehicle tank. A diaphragm is located in the cap and operates the fuel oil way and provides flow and stop of fuel oil. A pipe sheath is installed onto the dispenser pipe and connected to the cap. A holding spring secures the pipe sheath to body of the fuel oil dispenser. A trust pipe provides a set of trust mechanism resting on the tank inlet when it is attempted to insert pipe sheath into the diesel tank. A pushing spring is connected to the thrust pipe and pushed after the tank inlet is hit by the thrust pipe. A motion spindle transmits motion from the pushing spring to the diaphragm which is moved downward and provides closing.

### THE RELATED ART

Invention relates to fuel-oil dispensers filling vehicle tanks at fuel oil stations selling fuel-oil.

The invention particularly relates to filling apparatus which is mounted on fuel oil dispenser and prevents gasoline filling into diesel tanks.

### THE STATE OF ART

Today petrol stations have one or more than one pumps. Said pumps have different fuels such as gasoline, diesel etc. next to each other. The fuel (gasoline, diesel etc.) need of the vehicle at the pump for fuel oil is filled into vehicle tank by help of filling dispenser in the related chamber located on the pump.

In the prior art during filling up tank of vehicle, the station officer can take the filling dispenser from the wrong chamber and fill in different fuel oil.

In the related art in case of filling different fuel in the vehicle causes major damages in the vehicles.

In the related art since diesel or gasoline is not indicated on the vehicle and driver forgets to say it, fuel oil filling is made as per knowledge of the station officer. When station officer is absent minded for a second or has poor knowledge, above mentioned wrong fuel filling may happen.

In the related art, client and company experience unpleasant incidents because of damage occurring in the vehicle caused by wrong fuel oil filling. Station officer's fault defames the company's reputation.

When the literature is searched, various embodiments relating to the said fuel oil dispenser are seen. One of them is the application numbered 2011/06484 and titled “Fuel oil dispenser”. The abstract of the invention classified in class B67D7/48 reads as “A fuel oil pump for fuel consisting of a discharge pipe, a distribution valve and a hose connection, a valve housing having a turn off automatic for a starting lever and a carrying safe; wherein a distribution valve place is formed in the valve housing, and a distribution valve place connected with it is placed, wherein distribution valve body is activated by means of a hallow valve spindle wherein a traction bar is moved forward, wherein valve spindle and traction bar can be connected or removed by fixing mechanism associated with turning off automatic, wherein turning off automatic consists of a sensor channel for fullness level and a vacuum channel and a pressure balancing chamber and a chamber separating membrane, wherein valve spindle is moved inside a bearing housing, closing springs are placed inside this housing for valve spindle and traction bar, wherein distribution valve body has two closing components displacing axially in respect to each other, wherein an opening is provided inside distribution valve place area between them and a shaking embodiment passing through bearing housing is formed, operated by vacuum activated opening of distribution valve inside opening space area, Wherein shaking embodiment can be sealed by a second closing component.

Said application discloses a single type fuel oil dispenser conducting fuel oil filling. The dispenser can enter both gasoline and diesel tanks. For that reason, said application can be shown as example for above disadvantages.

Another example regarding said embodiment is a utility model application numbered TR2014/04451 titled “A casing” Falling under class B67D 7/00, the invention states in abstract section as: The present invention develops a casing placed on fuel oil dispenser consisting of a handle section wherein fuel oil is received from transmission member in a fuel oil pump and held by the user; a terminal end sending the received fuel oil to tank of a vehicle and a body section providing transmission of fuel oil received from handle section to terminal section in a controlled manner. Said casing consists of at least a casing body having at least two parts capable to move in respect to each other and connected fuel oil dispenser in a manner to surround body section of fuel-oil dispenser; at least a locking mechanism preventing movement of said parts in respect to each other after connection to casing body fuel oil dispenser and providing securing casing body to fuel oil dispenser; at least a housing located in casing body and surrounding terminal section of fuel oil dispenser, at least a handle connected to casing body from one side and surrounding handle section of fuel oil dispenser partially; at least an indicator member having at least an informing member located thereon.

This invention develops a casing to protect the fuel oil dispenser against strokes that might come externally. Similarly, this can enter into gasoline and diesel tanks easily and conduct filling. Therefore, this application can be shown as an example for some of advantages given above.

In conclusion, developments have been made in fuel oil dispensers in parallel to technology and, therefore, new embodiments eliminating the above disadvantages and offering solutions to existing systems are needed.

### PURPOSE OF THE INVENTION

The invention relates to fuel oil dispensers different from the embodiments used in the related art and developed to solve said disadvantages and providing some additional advantages.

Purpose of invention is to prevent pour of gasoline to tanks of diesel vehicles by filling apparatus. As the diameters of gasoline tank and diesel tank inlets are different from each other, the difference is used by filling dispenser.

Tank inlet of diesel vehicles is smaller than tank inlet of gasoline vehicles. Dispenser having filling apparatus can enter into gasoline tank easily. When it is attempted to put it into diesel tank, the thrust pipe coincides with tank inlet and sets the mechanism by means of pushing force received therefore and thus prevents start of fuel oil filling.

Another purpose of the invention is to prevent wrong fuel oil filling by help of filling apparatus. Thus major damage to vehicles all of a sudden is prevented.

Filling apparatus is a long-life, economical, quality, easy to use, easy to adjust and mount.

In order to achieve above purposes, a filling apparatus on fuel oil dispenser conducting gasoline and diesel filling, and installed onto dispenser and thus preventing pour of gasoline into diesel tank, has been developed. Said filling apparatus consists of a cap fixed onto fuel oil dispenser. Cap has a diaphragm turning on/off the fuel oil way and thus providing flow and stop of fuel oil. It has a pipe sheath installed onto said dispenser pipe and connected to cap. A holding spring helps securing said pipe sheath to body of fuel oil dispenser and slide of pipe sheath on dispenser pipe. When it is intended to insert said pipe sheath into diesel tank located on terminal end, mechanism is set by help of support resting on tank mouth. It consists of a pushing spring connected to said thrust pipe and pushed by means of motion in B direction following hitting tank inlet by thrust pipe. Motion from said pushing spring is proceeded and said diaphragm is moved downward and enables movement spindle to close. The structural and characteristic features and all advantages of the invention will be understood better in the figures given below and the detailed description by reference to the figures. Therefore, the assessment should be made based on the figures and the detailed descriptions.

### BRIEF DESCRIPTION OF DRAWINGS

FIG. 1 shows a perspective view of filing apparatus of the invention.

FIG. 2 shows two-dimension side view of filling apparatus of the invention.

FIG. 3 shows perspective view of motion spindle in cap of the filling apparatus of the invention.

FIG. 4 shows a perspective view of filing apparatus installed onto pump dispenser as disclosed under the invention.

FIG. 5 shows a perspective view of diaphragm located in cap section of the filing apparatus of the invention.

### REFERENCE NUMBERS

```
  10. Fuel oil dispenser
  11. Dispenser pipe
100. Filling apparatus
110. Cap
111. Fixing member
112. Diaphragm cover
120. Motion spindle
121. Lever arm
122. Fixing member
130. Set lever 1
131. Set lever fixing member
132. Gasket
140. Set lever 2
150. Pipe sheath
151. Holding spring
152. Nipple
153. Spring holder
154. Pushing spring
155. Trust pipe
160. Diaphragm
161. Diaphragm spindle
162. Flexible surface
163. Spindle connection part
164. Diaphragm fixing holes
```

### DETAILED DESCRIPTION OF THE INVENTION

### Embodiment Principle

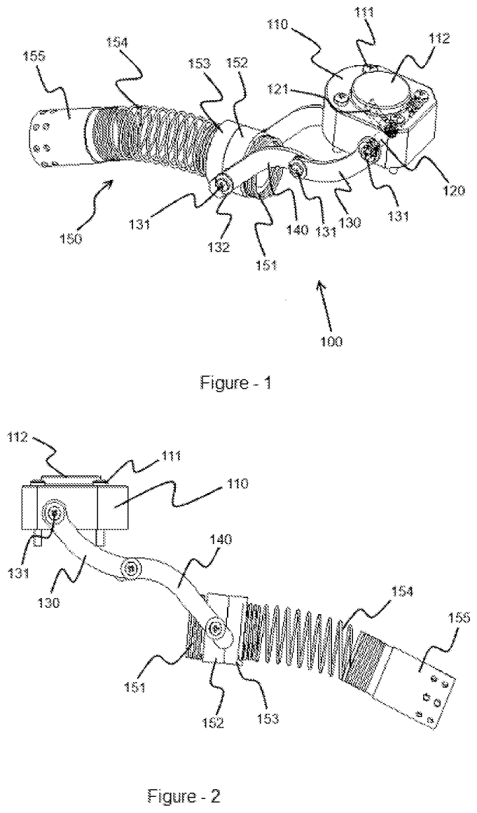

Filling apparatus (100) in general consists of a cap (110), a spindle (120), a set lever 1 (130), sheet 2 (140) and a pipe sheath (150). FIG. 1 shows perspective view of filling apparatus (100).

Said cap (110) spindle (120) and lever arm (121) provide opening-closing of diaphragm (160). Cap (110) is placed on fuel oil dispenser (10) and is connected to dispenser pipe (11) through which liquid flows. The cap (110) is fixed onto fuel-oil dispenser (10) by fixing members (111).

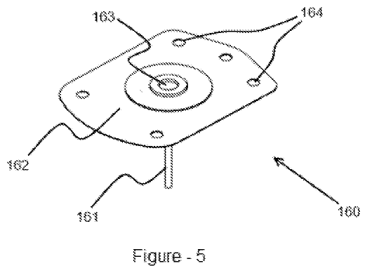

Diaphragm (160) is the member moving up and down on the cap (110) and thus opening and closing the dispenser pipe (11). Lower part of diaphragm (160) has a diaphragm spindle (161). Diaphragm spindle (161) is the component pushing assembly downward in order to prevent flow of fuel into dispenser pipe (11). General structure of diaphragm (160) is flexible surface (162). Centre of flexible surface (162) contains spindle connection part (163) providing fixing of diaphragm spindle (161) to flexible surface. In addition, edges of flexible surface (162) have diaphragm fixing holes (164) used for fixing the diaphragm (160) into cap (110), FIG. 5 is a perspective view of the diaphragm (160).

Diaphragm cover (112) is located in upper part of diaphragm (160) and thus diaphragm (160) is trapped into the cap (110).

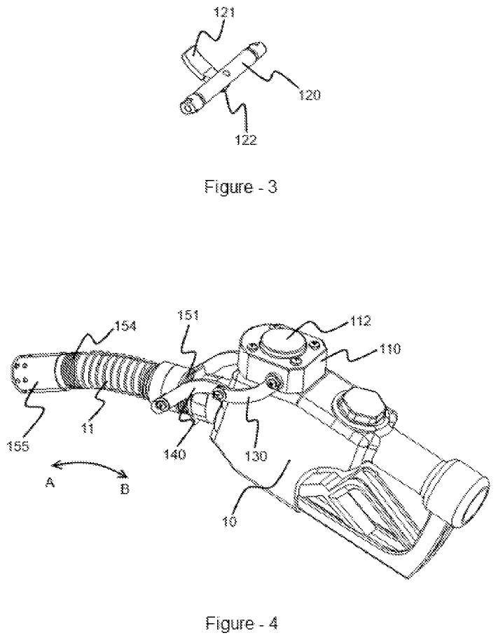

Motion spindle (120) is placed in the cap (110) horizontally. It plays active role in opening-closing actions of diaphragm (112). Lever arm (121) is located on motion spindle (120). Lever arm (121) is fixed onto motion spindle (120) by means of fixing member (122). Said lever arm (121) contacts flexible surface (162) of diaphragm (160) and moves diaphragm spindle (161) up and down. FIG. 3 is a perspective view of the motion spindle (120).

Set arm 1 (130) and sheet 2 (140) are interconnected by set arm fixing member (131) and provide interconnection of pipe sheath (150) and cap (110). It rotates and acts as joint where fixed to each other.

Set lever 1 (130) is fixed to motion spindle (120) inside the cap (110).

Sheet 2 (140) is fixed to set lever 1 (130) on one side and to pipe sheath (150) on the other side. The fixing operations are conducted by use of set lever fixing members (131). Gasket (132) is used to prevent loosing in set lever fixing members (131).

Pipe sheath (150) is the embodiment put onto dispenser pipe (11) and sliding onto the dispenser pipe (11) to move. Holding spring (151) consists of nipple (152), spring holder (153), pushing spring (154), trust pipe (155). FIGS. 1 and 2 show pipe sheath (150) and cap (110) embodiment clearly.

Holding spring (151) is a connection part used for centring. It provides connecting terminal part of pipe (11) of dispenser to upper part and provides connection of pipe sheath (150) to dispenser pipe (11).

Nipple (152) is the part providing installation of system wherein set lever arm 2 (140) is fixed to pipe sheath (150).

Spring holder (153) is the connection part providing connection of pushing spring (154) to the system.

Pushing spring (154) is the component inserted to trust pipe (155) and transmitting the motion from trust pipe (155) to set lever 2 (140).

Trust pipe (155) is the connection part providing activation of system by contacting fuel oil tank.

### Principle of Mounting

The cap (110) and pipe sheath (150) constituting filling apparatus (100) are interconnected by set lever 1 (130) and set lever 2 (140). The filling apparatus (100) with this connection is shown in FIG. 1.

Thereafter, firstly pipe sheath (150) is put onto the dispenser pipe (11) to fix onto the fuel oil dispenser (10). The cap (110) is located onto fuel oil dispenser (10).

The diaphragm (160) is located inside the cap (110). The motion spindle (120) to be connected to diaphragm (160) is fixed inside the cap (110) by means of fixing member (122). During fixing, the motion spindle (120) is connected to set levers 1 (130) from side edges and thus connected to the system.

This section is closed after location of the diaphragm cover (112) onto the cap (110). Diaphragm cover (112) is fixed onto the cap (110) by means of fixing members (111). The fixing members (111) also pass through diaphragm fixing holes (164) and fixing of diaphragm (160) into the cap (110) is provided.

It is in the form shown in FIG. 4 after this fixing. Trust pipe (155) located in the pipe sheath (150) may slide in direction B subject to pressure from outside, and when left free, restore to former position after sliding in direction A.

### Principle; of Operation

When gasoline is filled, trust pipe (155) grasping the dispenser pipe (11) rests on edges without entering tank hole while fuel oil dispenser (10) is inserted in vehicle tank. Meanwhile, when dispenser pipe (11) is pushed inward, the trust pipe moves in direction B. The trust pipe (155) moving in direction B also pushes the pushing spring (154) connected to it. Similarly, spring holder (153) and nipple (152) fixed to pushing spring (154) move in direction B.

Upon motion of all the members, set lever 2 (140) move in direction B. With this motion, set lever 1 (130) moves in direction B from the point where it is connected to set lever 2 (140) and the section fixed to the cap (110) starts to rotate around its axis.

Since set lever 1 (130) is fixed to motion spindle (120) inside the cap (110), the motion spindle (120) also rotates around its axis upon final motion of sheet 1. Rotation of motion spindle (120) around its axis moves the lever arm (121) downward. The lever arm (121) moving downward contacts the flexible surface (162) of the diaphragm (160) and lowers the flexible surface (162) in down direction. Flexible surface (162) moving downward moves the diaphragm spindle (161) connected to it and closes the inlet of dispenser pipe (11) and stops fuel oil flowing.

The invention is used to prevent pour of gasoline to diesel vehicles. The inlet section of fuel oil tank of diesel vehicle is narrower than inlet of tank of gasoline vehicle.

Filling apparatus (100) is installed onto the fuel oil dispensers (10) filing gasoline as described above. When petrol station officer attempts to put the fuel oil dispenser (10) into diesel vehicle tank by mistake, trust pipe (155) coincides with narrow diameter tank inlet and as stated, the mechanism is set and the diaphragm (160) closes the dispenser pipe (11) way. Thus pour of gasoline into diesel engine tank is prevented.

As stated above, since diameter of inlet part of fuel oil tank of gasoline vehicle is wider, it takes the dispenser pipe (11) having filling apparatus (100) installed thereon and provides progress of filling.

1. A filling apparatus conducting filling gasoline and diesel to vehicles at fuel oil stations and to be installed onto fuel oil dispenser comprising a dispenser pipe entering into a vehicle tank and it is characterized in comprising:
a cap located onto said fuel oil dispenser;
a diaphragm located in said and turning on/off the fuel oil way and providing flow and stop of fuel oil;
a pipe sheath installed onto said dispenser pipe and connected to the cap;
a holding spring helping secure of said pipe sheath to a body of the fuel oil dispenser and slide of pipe sheath on the dispenser pipe;
a trust pipe providing a set of trust mechanism resting on the tank inlet when it is intended to insert said pipe sheath into diesel tank located on terminal end;
a pushing spring connected to said thrust pipe and pushed by means of motion in B direction following hitting the tank inlet by the thrust pipe; and
a motion spindle where motion from said pushing spring is transmitted and said diaphragm is moved downward and providing closing.

2. A fuel oil dispenser according to claim 1, comprising, a lever arm fixed to said motion spindle and thus connected to diaphragm and therefore, providing up and down movement of diaphragm and preventing and allowing flow of fuel oil through dispenser pipe.

3. A fuel oil dispenser according to claim 2, comprising, a fixing member providing fix of said lever arm to said motion spindle.

4. A fuel oil dispenser according to claim 1, comprising, a set lever 1 connected to the motion spindle inside said cap and transmitting the motion from the pipe sheath to the motion spindle.

5. A fuel oil dispenser according to claim 4, comprising, a set lever 2 connected to said set lever 1 and pipe sheath and transmitting the motion from the pipe sheath to set lever 1.

6. A fuel oil dispenser according to claim 5, comprising, a nipple which is one of components constituting said pipe sheath and is fixed to said holder spring and thus connected to the set lever 2.

7. A fuel oil dispenser according to claim 6, comprising, a spring holder which is installed to said nipple, thus provides connection of the nipple to the pushing spring and provides incorporation of pushing spring into the system.

8. A fuel oil dispenser according to claim 1, comprising, a flexible surface which stretches downward due to pressure from lever arm of said diaphragm and moves upward and goes into former position when pressure from lever arm ends.

9. A fuel oil dispenser according to claim 8, comprising, a diaphragm spindle fixed under said flexible surface, sliding downward upon down movement of flexing surface and thus preventing flow of fuel oil to dispenser pipe.

10. A fuel oil dispenser according to claim 9, comprising, a spindle connection part formed in the central part of the flexible surface for fixing the said diaphragm spindle to the flexible surface.
